(19) United States
(12) Patent Application Publication
(10) Pub. No.: US 2008/0197657 A1
(43) Pub. Date: Aug. 21, 2008

(54) UPPER WINDSHIELD QUIET CLIP

(76) Inventors: Michael Scott Sutton, Hudson, OH (US); Dave Sunderhaus, Dublin, OH (US)

Correspondence Address: Emerson, Thomson & Bennett, LLC, 777 W. Market Street, Akron, OH, 44303, US

(21) Appl. No.: 11/961,137

(22) Filed: Dec. 20, 2007

Related U.S. Application Data
(60) Provisional application No. 60/877,812, filed on Dec. 29, 2006.

(51) Int. Cl. B60J 1/20

(52) U.S. Cl. 296/96.21

(57) ABSTRACT

A windshield clip may include a base that can be attached to a windshield surface and a post that extends from the base. The post may have an inner component and an outer component formed of substantially different compositions.

This application claims priority from U.S. Ser. No. 60/877,812, titled Upper Windshield Quiet Clip, filed Dec. 29, 2006, which is incorporated herein by reference.

### I. BACKGROUND OF THE INVENTION

A. Field of Invention

This invention pertains to the art of methods and apparatuses regarding the manufacture and assembly of vehicles, and more particularly to methods and apparatuses regarding the installation of vehicle windshields.

B. Description of the Related Art

It is well known to mount a window or windshield to a vehicle body. Typically, the vehicle body has an opening surrounded by a flange. An adhesive is applied to the flange and the windshield is placed against the adhesive. As the adhesive is curing, the weight of the windshield tends to cause the windshield to slide downwardly due to gravity. To prevent this undesirable sliding, it is necessary to support the weight of the windshield while the adhesive cures.

It is known in the automotive industry to use upper windshield clips to support the weight of the windshield and to prevent the windshield from sliding as the adhesive cures. Conventional windshield clips typically include a base pad and a post. The base pad can be adhered to the windshield's inner surface such that it is between the windshield and the flange. The post may protrude from the base and away from the windshield inner surface. The flange can be equipped with a corresponding flange aperture suitable for receiving the post of the upper windshield clip. The upper windshield clip can be positioned on the windshield such that when the adhesive is applied to the flange, and the windshield is placed against the adhesive, the post protrudes from the base and extends through the flange aperture thereby preventing the windshield from sliding downward.

One disadvantage to current windshield clip design is the noise or “squeak” that results from the windshield clip rubbing against the automotive frame, which is typically formed of sheet-metal. This “squeaking” is especially prominent during rough-road and/or cold-driving conditions. What is needed then is a windshield clip that improves performance and reduces the noise or “squeaks” that result during operation of the automobile on rough-road and/or cold-driving conditions.

### II. SUMMARY OF THE INVENTION

According to one embodiment of this invention, a windshield clip comprises a base for use in being attached to the surface of an associated windshield and a post for use in being attached to an associated vehicle. The post extends from the base and has a first inner component and a second outer component. The first inner component and the second outer component are formed of different compositions.

According to another embodiment of this invention, a windshield clip comprises a base for use in being attached to the surface of an associated windshield and a post for use in being attached to an associated vehicle. The post extends from the base and has a first inner component and a second outer component. The first inner component and the second outer component are formed of different compositions. The second outer component substantially encapsulates the exterior surface of the first inner component.

According to another embodiment of this invention, a windshield clip comprises a base for use in being attached to the surface of an associated windshield and a post for use in being attached to an associated vehicle. The post extends from the base and has a first inner component and a second outer component. The first inner component and the second outer component are formed of different compositions. The base has a substantially planar surface that can be attached to a windshield surface.

According to another embodiment of this invention, a windshield clip comprises a base for use in being attached to the surface of an associated windshield and a post for use in being attached to an associated vehicle. The post extends from the base and has a first inner component and a second outer component. The first inner component and the second outer component are formed of different compositions. The base has a substantially planar surface that has an adhesive thereon and can be attached to a windshield surface.

According to another embodiment of this invention, a windshield clip comprises a base for use in being attached to the surface of an associated windshield and a post for use in being attached to an associated vehicle. The post extends from the base and has a first inner component and a second outer component. The first inner component and the second outer component are formed of different compositions. The second outer component is formed of a softer composition than the first inner component.

According to still another embodiment of this invention, a windshield clip comprises a base for use in being attached to the surface of an associated windshield and a post for use in being attached to an associated vehicle. The post extends from the base and has a first inner component and a second outer component. The first inner component and the second outer component are formed of different compositions. The first inner component is formed of a plastic and the second outer component is formed of a rubber.

According to another embodiment of this invention, a windshield clip comprises a base for use in being attached to the surface of an associated windshield and a post for use in being attached to an associated vehicle. The post extends from the base and has a first inner component and a second outer component. The first inner component and the second outer component are formed of different compositions. The first inner component and the second outer component are co-injected molded.

According to another embodiment of this invention, a vehicle has a vehicle body, a windshield, and at least a first upper windshield clip. The vehicle body has a windshield opening and at least a first aperture juxtaposed to the windshield opening. The windshield has an upper portion and a lower portion. The windshield is positioned to at least partially cover the windshield opening. The upper windshield clip has a base and a post. The base is attached to the upper portion of the windshield. The post extends from the base and is received within the first aperture. The post has at least a first inner component and a second outer component. The first inner component and the first outer component are formed of different materials.

According to another embodiment of this invention, a vehicle has a vehicle body, a windshield, and at least a first upper windshield clip. The vehicle body has a windshield opening and at least a first aperture juxtaposed to the windshield opening. The windshield has an upper portion and a lower portion. The windshield is positioned to at least partially cover the windshield opening. The upper windshield clip has a base and a post. The base is attached to the upper portion of the windshield with an adhesive. The post extends from the base and is received within the first aperture. The post has at least a first inner component and a second outer component. The first inner component and the first outer component are formed of different materials.

According to another embodiment of this invention, a vehicle has a vehicle body, a windshield, and at least a first upper windshield clip. The vehicle body has a windshield opening and at least a first aperture juxtaposed to the windshield opening. The windshield has an upper portion and a lower portion. The windshield is positioned to at least partially cover the windshield opening. The upper windshield clip has a base and a post. The base is attached to the upper portion of the windshield. The post extends from the base and is received within the first aperture. The post has at least a first inner component and a second outer component. The first inner component and the first outer component are formed of different materials. The second outer component substantially encapsulates the exterior surface of the first inner component.

According to another embodiment of this invention, a vehicle has a vehicle body, a windshield, and at least a first upper windshield clip. The vehicle body has a windshield opening and at least a first aperture juxtaposed to the windshield opening. The windshield has an upper portion and a lower portion. The windshield is positioned to at least partially cover the windshield opening. The upper windshield clip has a base and a post. The base has a substantially planar surface that is attached to the upper portion of the windshield. The post extends from the base and is received within the first aperture. The post has at least a first inner component and a second outer component. The first inner component and the first outer component are formed of different materials.

According to another embodiment of this invention, a vehicle has a vehicle body, a windshield, and at least a first upper windshield clip. The vehicle body has a windshield opening and at least a first aperture juxtaposed to the windshield opening. The windshield has an upper portion and a lower portion. The windshield is positioned to at least partially cover the windshield opening. The upper windshield clip has a base and a post. The base has a substantially planar surface that has an adhesive on it and is attached to the upper portion of the windshield. The post extends from the base and is received within the first aperture. The post has at least a first inner component and a second outer component. The first inner component and the first outer component are formed of different materials.

According to another embodiment of this invention, a vehicle has a vehicle body, a windshield, and at least a first upper windshield clip. The vehicle body has a windshield opening and at least a first aperture juxtaposed to the windshield opening. The windshield has an upper portion and a lower portion. The windshield is positioned to at least partially cover the windshield opening. The upper windshield clip has a base and a post. The base is attached to the upper portion of the windshield. The post extends from the base and is received within the first aperture. The post has at least a first inner component and a second outer component. The first inner component and the first outer component are formed of different materials. The second outer component is formed of a softer composition than the first inner component.

According to another embodiment of this invention, a vehicle has a vehicle body, a windshield, and at least a first upper windshield clip. The vehicle body has a windshield opening and at least a first aperture juxtaposed to the windshield opening. The windshield has an upper portion and a lower portion. The windshield is positioned to at least partially cover the windshield opening. The upper windshield clip has a base and a post. The base is attached to the upper portion of the windshield. The post extends from the base and is received within the first aperture. The post has at least a first inner component and a second outer component. The first inner component and the first outer component are formed of different materials. The second outer component is formed of a rubber and the first inner component is formed of a plastic.

According to another embodiment of this invention, a vehicle has a vehicle body, a windshield, and at least a first upper windshield clip. The vehicle body has a windshield opening and at least a first aperture juxtaposed to the windshield opening. The windshield has an upper portion and a lower portion. The windshield is positioned to at least partially cover the windshield opening. The upper windshield clip has a base and a post. The base is attached to the upper portion of the windshield. The post extends from the base and is received within the first aperture. The post has at least a first inner component and a second outer component. The first inner component and the first outer component are formed of different materials. The first inner component and the second outer component are co-injected molded.

According to another embodiment of this invention, a vehicle has a vehicle body, a windshield, a first upper windshield clip, at least a first lower clip, and a second upper windshield clip. The vehicle body has a windshield opening and a first and a second aperture juxtaposed to the windshield opening. The windshield has an upper portion and a lower portion. The windshield is positioned to at least partially cover the windshield opening. The upper windshield clip has a base and a post. The base is attached to the upper portion of the windshield. The post extends from the base and is received within the first aperture. The post has at least a first inner component and a second outer component. The first inner component and the first outer component are formed of different materials. The first lower clip supports the lower portion of the windshield. The second upper windshield clip has a base and a post. The base is attached to the upper portion of the windshield. The post extends from the base and is received within the second aperture. The post has at least a first inner component and a second outer component. The first inner component and the second outer component are formed of different compositions.

According to one embodiment of this invention, a method comprises the steps of making a windshield clip having a base and a post. The base can be attached to an associated windshield surface. The post extends from the base and can be attached to an associated vehicle. The step of making the windshield has the step of forming the base to have at least a first inner component and a second outer component that are formed of substantially different compositions.

According to another embodiment of this invention, a method comprises the steps of making a windshield clip having a base and a post. The base can be attached to an associated windshield surface. The post extends from the base and can be attached to an associated vehicle. The step of making the windshield has the step of forming the base to have at least a first inner component and a second outer component that are formed of substantially different compositions and the step of forming the second outer component of a softer composition than the first inner component.

According to another embodiment of this invention, a method comprises the steps of making a windshield clip having a base and a post. The base can be attached to an associated windshield surface. The post extends from the base and can be attached to an associated vehicle. The step of making the windshield has the step of forming the base to have at least a first inner component and a second outer component that are formed of substantially different compositions and the step of forming the outer component of a rubber and the first inner component of a plastic.

According to still another embodiment of this invention, a method comprises the steps of making a windshield clip having a base and a post. The base can be attached to an associated windshield surface. The post extends from the base and can be attached to an associated vehicle. The step of making the windshield has the step of forming the base to have at least a first inner component and a second outer component that are formed of substantially different compositions and the step of co-injection molding the first inner component and the second outer component.

One advantage of this invention is that it substantially eliminates any noise or “squeaking” produced as a result of a windshield post coming into contact with the sheet-metal of an automobile frame. This is especially true when operating the automobile in rough road and/or cold-driving conditions.

Still other benefits and advantages will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of a vehicle comprising a windshield clip according to this invention.

FIG. 2 is a perspective view showing a windshield being positioned onto a vehicle according to one embodiment of this invention.

FIG. 3 is a side view of an assembled windshield clip according to one embodiment of this invention.

FIG. 4 is a side view of the windshield clip of FIG. 3 but in a pre-assembled condition.

FIG. 5 is a sectional view of FIG. 1 along Line A-A.

FIG. 6 is a flowchart showing a method for manufacture of a windshield clip by over-molding a second outer component atop a first inner component according to one embodiment of this invention.

FIG. 7 is a flowchart showing a method for manufacture of a windshield clip by co-injecting two distinct compositions to form a first inner component and a second outer component according to one embodiment of this invention.

### IV. DETAILED DESCRIPTION OF THE INVENTION

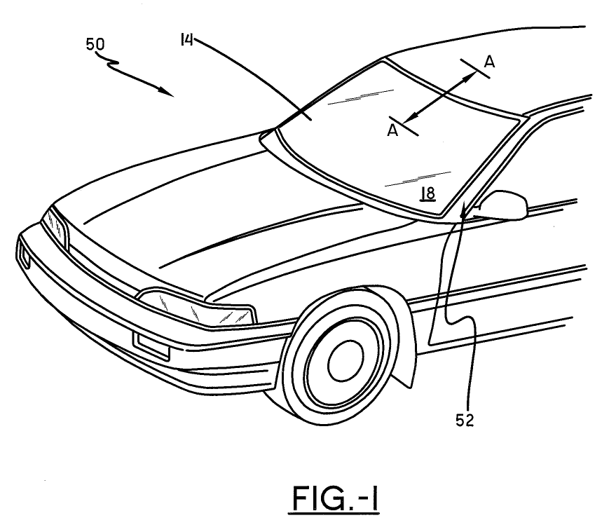

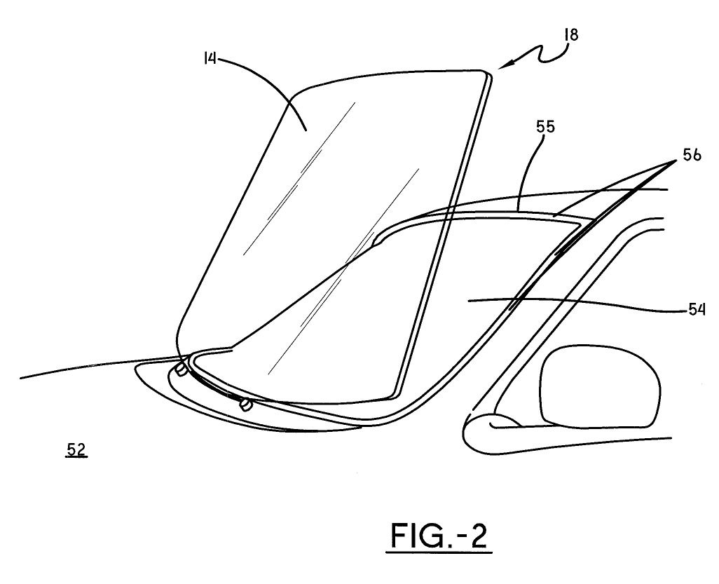

Referring now to the drawings wherein the showings are for purposes of illustrating embodiments of the invention only and not for purposes of limiting the same, FIGS. 1-2 show a vehicle 50 comprising an vehicle body 52, a windshield opening 54 and a windshield 14. The type of vehicle shown is a passenger vehicle but this is not intended to limit the invention because the invention may be used on other types of vehicles using windshields. For purposes of this invention, a windshield can be a window or any “see through” device mounted to a vehicle. The windshield may be formed of glass, plastic or any other material chosen with sound engineering judgment. Although only a front windshield is described, a windshield may also be located on the side or rear portions of the vehicle.

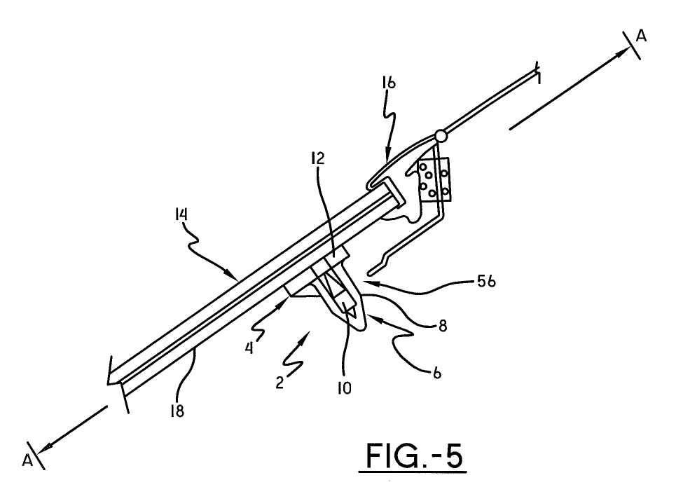

With reference now to FIGS. 1-2, 5, the vehicle body 52 may have a flange 55. The flange 55 may border the windshield opening 54 and may comprise at least a first flange aperture 56 (as shown in FIG. 5). The windshield 14 may comprise an inner windshield surface 18 and an outer windshield surface 19. The windshield 14 may be positioned adjacent to the flange 55 such that the inner windshield surface 18 is juxtaposed to the flange 55 and the windshield 14 substantially covers the windshield opening 54.

With reference now to FIGS. 1-6, an upper windshield clip 2 may comprise a base pad 4 and a post 6. The base pad 4 may comprise a mounting surface 12. The particular size, shape and orientation of the mounting surface 12 can be varied in order to accommodate the shape or curvature of inner window surface 18 upon which windshield clip 2 is to be mounted via mounting surface 12. In one embodiment of the invention, the mounting surface 12 may comprise a substantially planar surface. The mounting surface 12 of base pad 4 can be attached to inner windshield surface 18 using methods known in the art and chosen with sound engineering judgment. As a non-limiting example, mounting surface 12 may have an adhesive applied thereon onto which the windshield 14 is attached. Useful adhesives to be applied upon the mounting surface 12 can be selected and applied in accordance with sound engineering judgment.

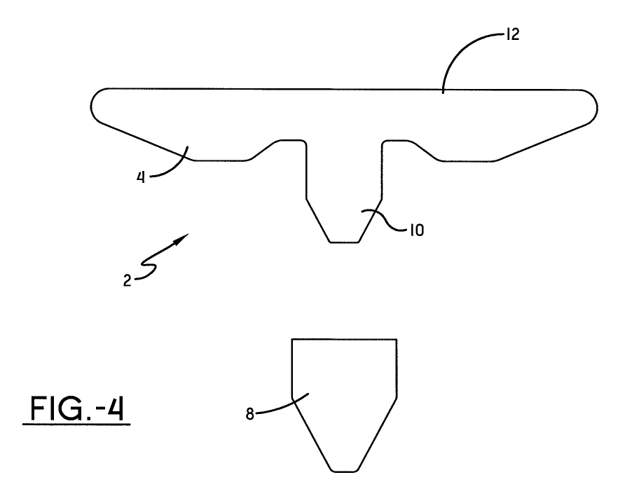

With continuing reference to FIGS. 1-6, the post 6 may extend from the base pad 4. The post 6 may be mounted to the base pad 4 using an adhesive or any method selected with sound engineering judgment. The post 6 may protrude from the base pad 4 at an angle A1. The angle A1 may be substantially perpendicular to the mounting surface 12. The post 6 may protrude at any angle with respect to the mounting surface 12 chosen with sound engineering judgment. The post 6 may have, as seen best in FIG. 4, an inner component 10 and an outer component 8. The outer component 8 may at least partially cover the exterior surface of the inner component 10. The diameter and overall length of the inner component 10 and the outer component 8 may be varied based upon the overall design of the post 6 and sound engineering judgment.

With continuing reference to FIGS. 1-6, the inner component 10 and the outer component 8 may be manufactured from distinct compositions. In one embodiment, the composition used to construct the inner component 10 is substantially harder than the composition used to construct the outer component 8. The hardness measurements of the distinct compositions used to construct the inner component 10 and the outer component 8 may be determined using methods known in the art. A non-limiting example of such a test method for determining hardness is a method known as Rockwell Hardness. Any other known method for determining the hardness of a composition selected with sound engineering judgment may be employed and is useful in practicing the present embodiments. A non-limiting list of useful materials for manufacturing a first inner component 10 includes plastic, rubber, fillers, additives and combinations thereof.

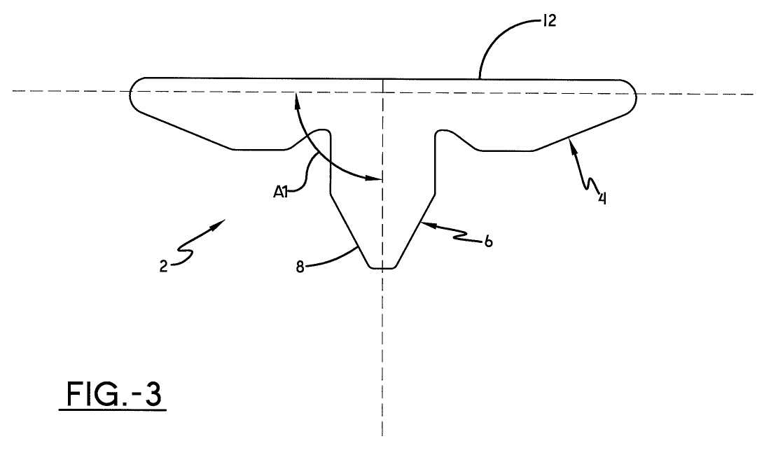

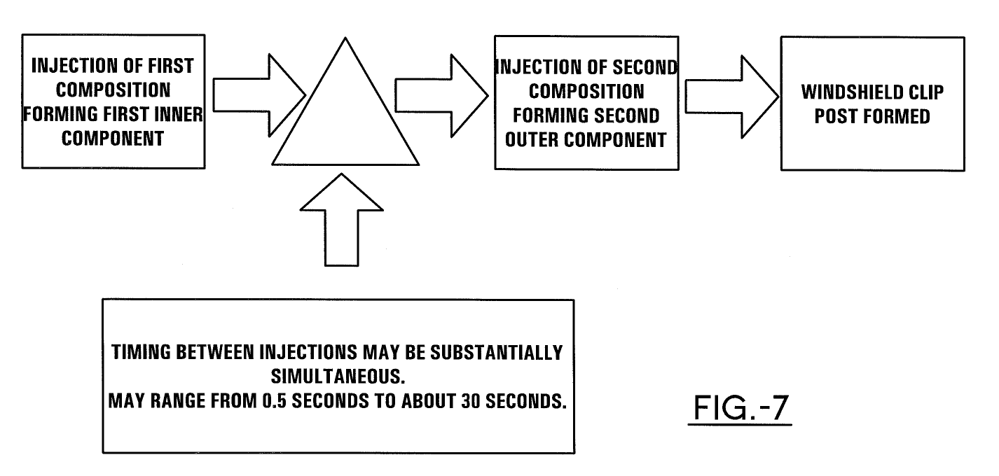

With reference now to FIGS. 3-8, the outer component 8 may form the exterior surface of the post 6. Furthermore, the outer component 8 may substantially encapsulate the exterior surface of the first inner component 10. The outer component 8 may be made of a composition or material that is relatively softer than the composition or material used to manufacture the inner component 10. Generally, the outer component 8 may be manufactured from a rubber or similar material or composition selected with sound engineering judgment. The relative softness of the outer component 8 generally improves fit and reduces squeaking or noise that can be attributed to the friction resulting from the mounting of the post 6 to the flange 55. As noted above, it is typical for the flange 55 to be constructed from a steel or metallic composition. A non-limiting list of useful compositions that may be used to construct the outer component 8 includes rubber, foam, plastics and combinations thereof. The windshield clip 2 may be manufactured using any known molding process chosen with sound engineering judgment. A non-limiting example of a molding process that may be used to manufacture the windshield clip 2 is a co-injection molding process. A co-injection molding process involves injecting two distinct compositions. The first composition may be directed to forming the inner component 10 and the second composition may be directed to forming the outer component 8. The compositions may be injected either simultaneously or at independently of one another and any apparatus suitable for manufacturing items via an injection molding process chosen with sound engineering judgment may be used with this invention.

With reference now to FIGS. 1-8, according to one embodiment of the invention, the windshield clip 2 may be attached to the top or upper perimeter of the windshield 14. Then, the windshield 14 may be positioned adjacent to the flange 55 such that the inner windshield surface 18 is juxtaposed to the flange 55 and the windshield 14 substantially covers the windshield opening 54. In one embodiment of the invention, the windshield 14 may be positioned adjacent to the flange 55 such that the flange aperture 56, located on the top or upper portion of the flange 55, may receive the post 6 of the windshield clip 2. The post 6 may extend, therefore, through the flange aperture 56. More specifically, the post 6 extends through flange aperture 56 such that the outer component 8 contacts the flange 55. An adhesive or a sealant may now be applied to permanently attach the windshield 14 to the vehicle frame 52 and to prevent moisture or other particles from passing through the windshield opening 54. The windshield clip 2 at least partially enables the windshield 14 to remain in a fixed position while the adhesive or sealant cures. In one embodiment of the invention, after the adhesive or sealant cures, the windshield clip 2 may remain attached to the windshield 14.

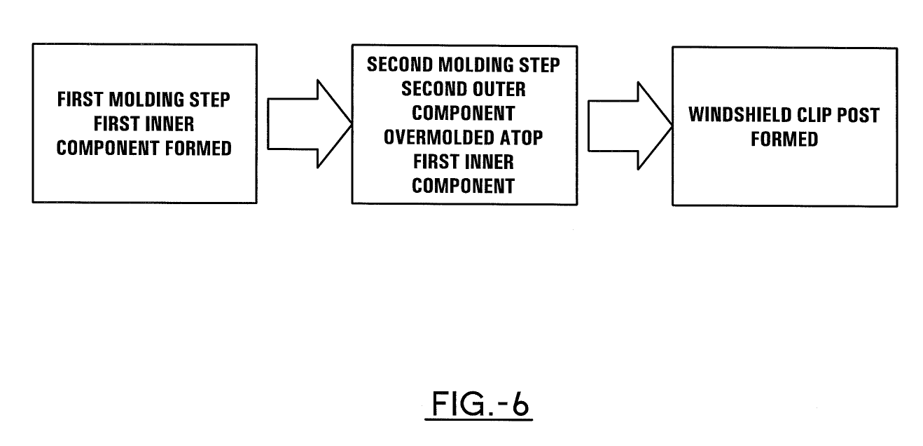

With reference now to FIG. 6, the windshield clip 2 may be used to mount any known type of automotive or vehicle windshield chosen with sound engineering judgment. The windshield clip 2 may be attached to the windshield 14 at a location proximate to the perimeter of windshield 14 or any location chosen with sound engineering judgment. Furthermore, one or more windshield clips 2 may be attached to the windshield 14 at positions on the windshield 14 that are generally proximate to the top or upper portion of the flange 55 or any other location chosen with sound engineering judgment.

Various embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. A windshield clip comprising:
a base for use in being attached to the surface of an associated windshield; and,
a post for use in being attached to an associated vehicle, the post-extends from the base and comprises a first inner component and a second outer component, wherein the first inner component and the second outer component are formed of different compositions.

2. The windshield clip of claim 1 wherein the second outer component substantially encapsulates the exterior surface of the first inner component.

3. The windshield clip of claim 1 wherein the base comprises a substantially planar surface that can be attached to a windshield surface.

4. The windshield clip of claim 3 wherein the substantially planar surface has an adhesive thereon.

5. The windshield clip of claim 1 wherein the second outer component is formed of a softer composition than the first inner component.

6. The windshield clip of claim 1 wherein the second outer component is formed of a rubber and the first inner component is formed of a plastic.

7. The windshield clip of claim 1 wherein the first inner component and the second outer component are co-injection molded.

8. A vehicle comprising:
a vehicle body having an windshield opening and at least a first aperture juxtaposed to the windshield opening;
a windshield having an upper portion and a lower portion, the windshield being positioned to at least partially cover the windshield opening; and,
at least a first upper windshield clip comprising:
(a) a base that is attached to the upper portion of the windshield; and,
(b) a post that extends from the base and that is received within the first aperture, the post comprising at least a first inner component and a second outer component, wherein the first inner component and the second outer component are formed of different compositions.

9. The vehicle of claim 8 wherein the base is attached to the upper portion of the windshield with an adhesive.

10. The vehicle of claim 8 wherein the second outer component substantially encapsulates the exterior surface of the first inner component.

11. The vehicle of claim 8 wherein the base comprises a substantially planar surface that is attached to the windshield.

12. The vehicle of claim 11 wherein the substantially planar surface has an adhesive thereon.

13. The vehicle of claim 8 wherein the second outer component is formed of a softer composition than the first inner component.

14. The vehicle of claim 8 wherein the second outer component is formed of a rubber and the first inner component is formed of a plastic.

15. The vehicle of claim 8 wherein the first inner component and the second outer component are co-injection molded.

16. The vehicle of claim 8 further comprising:
at least a first lower windshield clip that supports the lower portion of the windshield; and,
a second upper windshield clip comprising:
(a) a base that is attached to the upper portion of the windshield; and,
(b) a post that extends from the base and that is received within a second aperture, the post comprising at least a first inner component and a second outer component, wherein the first inner component and the second outer component are formed of different compositions.

17. A method comprising the steps of:
making a windshield clip having a base that can be attached to an associated windshield surface and a post that extends from the base and can be attached to an associated vehicle; and,
wherein the step of, making the windshield clip, comprises the step of forming the base to comprise at least a first inner component and a second outer component that are formed of substantially different compositions.

18. The method of claim 17 wherein the step of, forming the base to comprise at least a first inner component and a second outer component, comprises the step of:
forming the second outer component of a softer composition than the first inner component.

19. The method of claim 17 wherein the step of, forming the base to comprise at least a first inner component and a second outer component, comprises the step of:
forming the second outer component of a rubber and the first inner component of a plastic.

20. The method of claim 17 wherein the step of, forming the base to comprise at least a first inner component and a second outer component, comprises the step of:
co-injection molding the first inner component and the second outer component.
